(19) United States
(12) Patent Application Publication
(10) Pub. No.: US 2008/0097907 A1
(43) Pub. Date: Apr. 24, 2008

(54) Methods of operating a self-service check depositing terminal to deposit a plurality of checks in a single deposit transaction

(75) Inventors: Ronald Ian Till, Newmarket (CA); Malon Sim Updike, Dayton, OH (US); Cheri Lynn Roe, Kitchener (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/585,730

(22) Filed: Oct. 24, 2006

(51) Int. Cl. G06Q 40/00

(52) U.S. Cl. 705/45

(57) ABSTRACT

A method is provided of operating a self-service check depositing terminal having a single-check acceptor. The method comprises receiving a request from a depositor to conduct a check deposit transaction to deposit a plurality of checks, after receiving the request, obtaining an authorization to allow the depositor to conduct the check deposit transaction to deposit the plurality of checks, after obtaining the authorization, sequentially receiving the plurality of checks from the depositor, and after receiving the plurality of checks, providing a single check deposit transaction message to allow the check deposit transaction to be completed.

### BACKGROUND

The present invention relates to depositing of checks, and is particularly directed to methods of operating a self-service check depositing terminal, such as a check depositing automated teller machine (ATM), to deposit a plurality of checks in a single deposit transaction.

In a typical check depositing ATM, an ATM customer is allowed to deposit a check (without having to place the check in any deposit envelope) in a publicly accessible, unattended environment. To deposit a check, the ATM customer inserts a user identification card through a user card slot at the ATM, enters the amount of the check being deposited, and inserts the check to be deposited through a check slot of a check acceptor. A check transport mechanism receives the inserted check and transports the check in a forward direction along a check transport path to a number of locations within the ATM to process the check.

If the check is not accepted for deposit, the check transport mechanism transports the check in a reverse direction along the check transport path to return the check to the ATM customer via the check slot. If the check is accepted for deposit, the amount of the check is deposited into the ATM customer's account and the check is transported to a storage bin within the ATM. An endorser printer prints an endorsement onto the check as the check is being transported to and stored in the storage bin. The ATM customer may be charged a service fee for conducting the check deposit transaction. Checks in the storage bin within the ATM are periodically picked up and physically transported via courier to a back office facility of a financial institution for further processing.

In known ATMs, the check acceptor accepts one check for deposit in the check deposit transaction. If the ATM customer has another check to deposit, the ATM customer needs to start and complete a second check deposit transaction. If the ATM customer is charged a service fee for conducting a check deposit transaction, then the ATM customer is charged another service fee for having conducted this second check deposit transaction. Additionally, the owner of the ATM may be charged a “click fee” for each check depositing transaction conducted at the ATM. If this is the case and the ATM customer needs to conduct the second check deposit transaction, the ATM owner will be charged a second click fee. It would be desirable to provide the ATM customer with the capability to deposit multiple check items without having either the ATM customer incur multiple service fees or the ATM owner incur multiple click fees.

### SUMMARY

In accordance with an embodiment of the present invention, a method is provided of operating a self-service check depositing terminal having a single-check acceptor. The method comprises receiving a request from a depositor to conduct a check deposit transaction to deposit a plurality of checks, after receiving the request, obtaining an authorization to allow the depositor to conduct the check deposit transaction to deposit the plurality of checks, after obtaining the authorization, sequentially receiving the plurality of checks from the depositor, and after receiving the plurality of checks, providing a single check deposit transaction message to allow the check deposit transaction to be completed.

### BRIEF DESCRIPTION OF THE DRAWINGS

In the accompanying drawings:

FIG. 1 is a left-front perspective view of an image-based check depositing automated teller machine (ATM) embodying the present invention;

FIG. 2 is a simplified schematic diagram of a part (a check processing module) of the ATM of FIG. 1;

FIG. 3 is an elevational view of the check processing module of FIG. 2, looking approximately in the direction of arrow X in FIG. 1, and showing some parts removed and some parts only schematically;

FIG. 4 is a flowchart illustrating steps involved in a check depositing operation in accordance with an embodiment of the present invention; and

FIG. 5 is a flowchart illustrating steps involved in a check depositing operation in accordance with another embodiment of the present invention.

### DETAILED DESCRIPTION

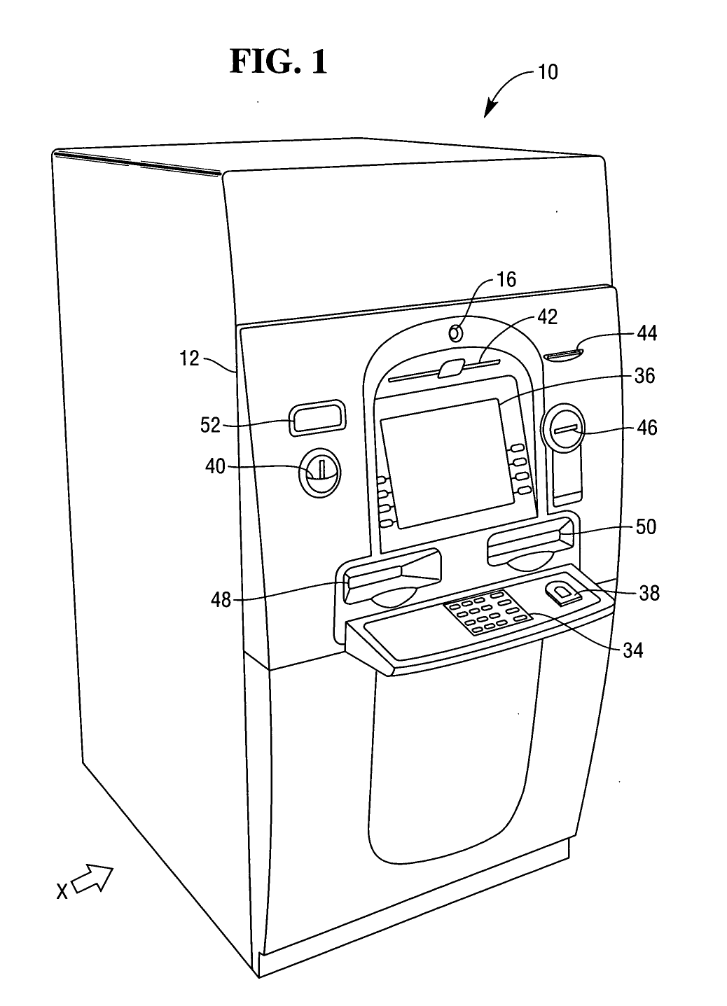

Referring to FIG. 1, a self-service check depositing terminal in the form of an image-based check depositing automated teller machine (ATM) 10 is illustrated. The check depositing ATM 10 comprises a fascia 12 coupled to a chassis (not shown). The fascia 12 defines an aperture 16 through which a camera (not shown) images a customer of the ATM 10. The fascia 12 also defines a number of slots for receiving and dispensing media items, and a tray 40 into which coins can be dispensed. The slots include a statement output slot 42, a receipt slot 44, a card reader slot 46, a cash slot 48, another cash slot 50, and a check input/output slot 52. The slots 42 to 52 and tray 40 are arranged such that the slots and tray align with corresponding ATM modules mounted within the chassis of the ATM 10.

The fascia 12 provides a user interface for allowing an ATM customer to execute a transaction. The fascia 12 includes an encrypting keyboard 34 for allowing an ATM customer to enter transaction details. A display 36 is provided for presenting screens to an ATM customer. A fingerprint reader 38 is provided for reading a fingerprint of an ATM customer to identify the ATM customer. The user interface features described above are all provided on an NCR PERSONAS (trademark) 6676 ATM, available from NCR Financial Solutions Group Limited, Discovery Centre, 3 Fulton Road, Dundee, DD2 4SW, Scotland.

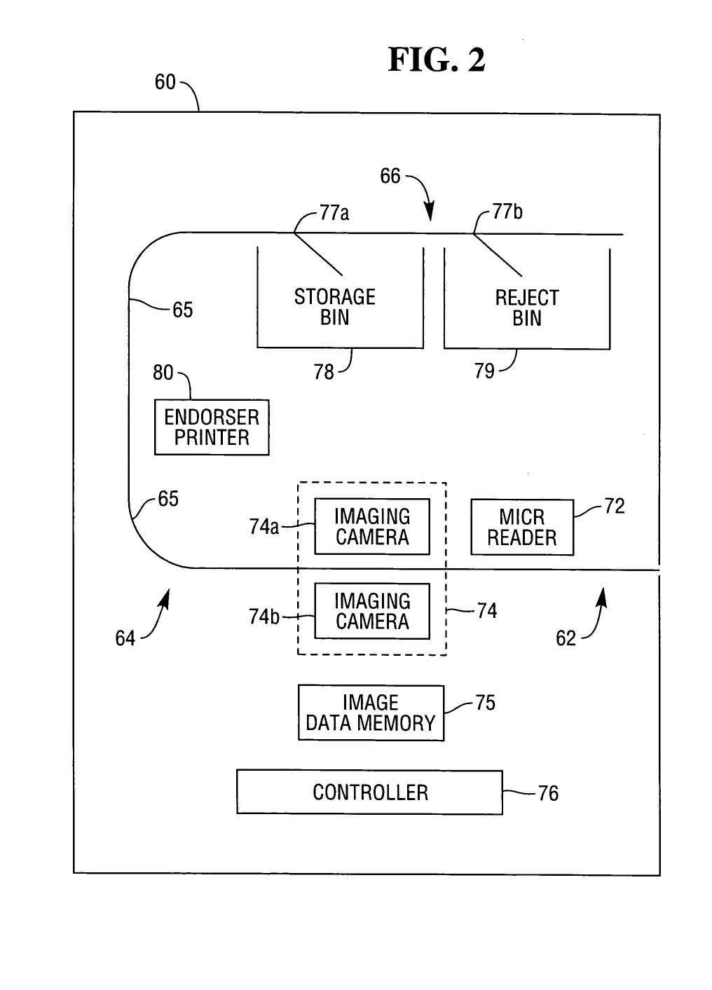

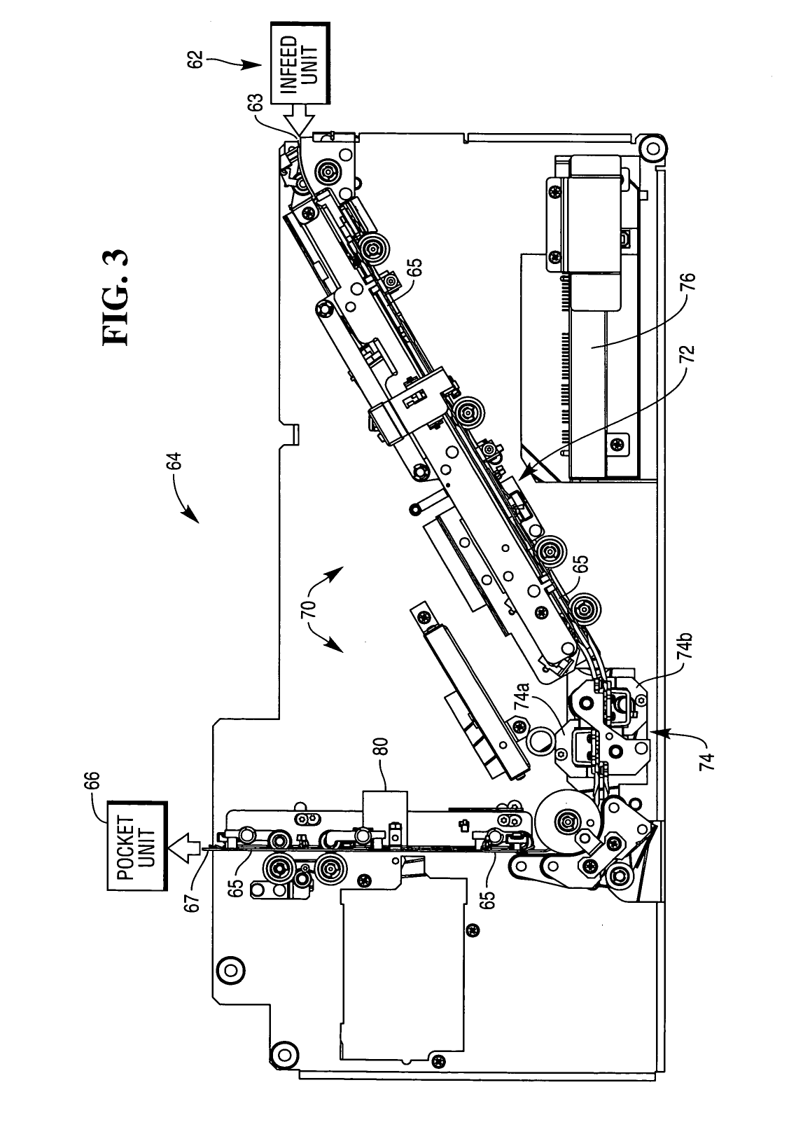

A check processing module (CPM) 60 will now be described with reference to FIG. 2 and FIG. 3. FIG. 2 is a simplified schematic diagram of part of the fascia 12 and main parts of the CPM 60. FIG. 3 is an elevational view of the check processing module of FIG. 2, looking approximately in the direction of arrow X in FIG. 1, and showing some parts removed and some parts only schematically. The CPM 60 is a modified version of a conventional check processing module, such as the check processing module provided with the PERSONAS (trademark) 6676 NCR ATM.

The CPM 60 comprises three main units which includes an infeed unit 62, a transport unit 64, and a pocket unit 66. The infeed unit 62 receives a check which has been deposited into the check input/output slot 42, and transports the check to an inlet 63 of the transport unit 64. The dimensions of the infeed unit 62, such as its run length, may vary depending upon the particular model ATM the CPM 60 is installed. The structure and operation of the infeed unit 62 are conventional and well known and, therefore, will not be described.

The transport unit 64 includes a check input/output transport mechanism 70 which includes an alignment mechanism for aligning a check. The transport mechanism 70 receives a check from the inlet 63, and transports the check along a document track 65 to an outlet 67 of the transport unit 64. The transport unit 64 further includes a magnetic ink character recognition (MICR) head 72 for reading magnetic details on a code line of a check. The transport unit 64 also includes an imager 74 including an upper 74a and lower 74b imaging camera for capturing an image of each side of a check (front and rear). An endorser printer 80 is provided for printing endorsements onto checks. An image data memory 75 is provided for storing images of checks. A controller 76 is provided for controlling the operation of the elements within the CPM 60.

The pocket unit 66 includes a storage bin 78 for storing processed checks. The pocket unit 66 further includes a reject bin 79 for storing rejected checks. Two divert gates 77a, 77b are provided for diverting checks to either the storage bin 78 or the reject bin 79. The structure and operation of the pocket unit 66 are conventional and well known and, therefore, will not be described.

The CPM 60 is of a type which processes only one check at a time. Once a check is received for processing, the check must be deposited into a bin (i.e., either the storage bin 78 or the reject bin 79) before another check can be received for processing. This type of check processing module is sometime referred to as a single-check acceptor.

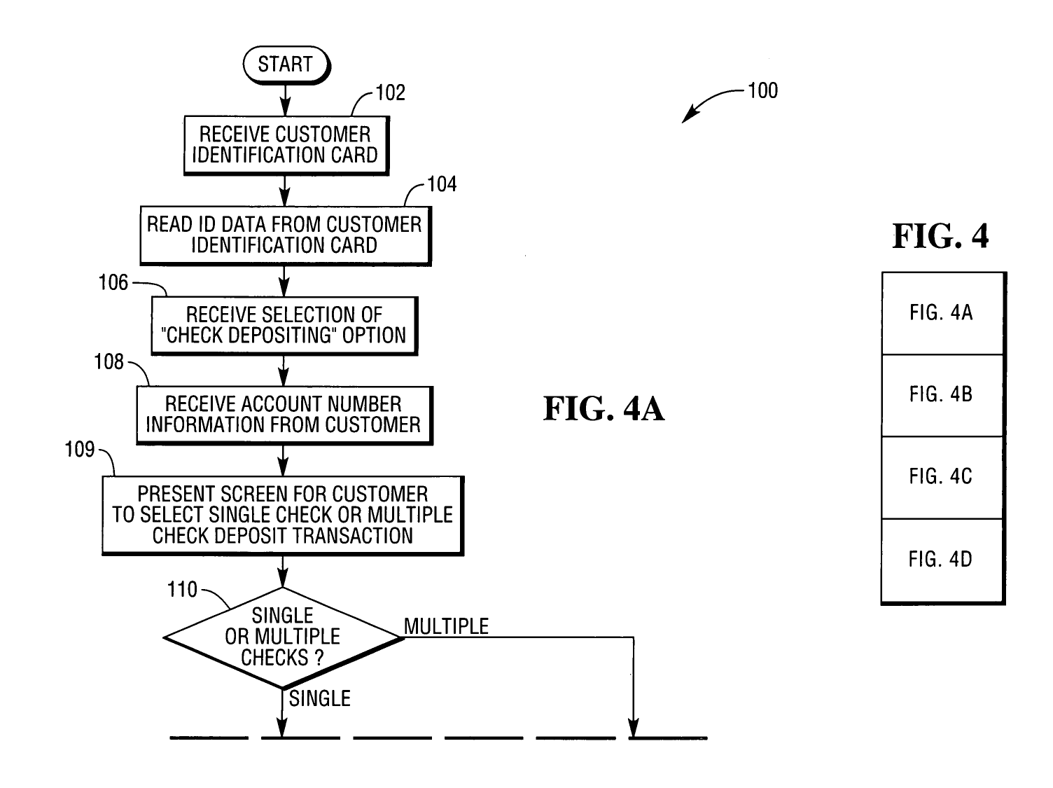

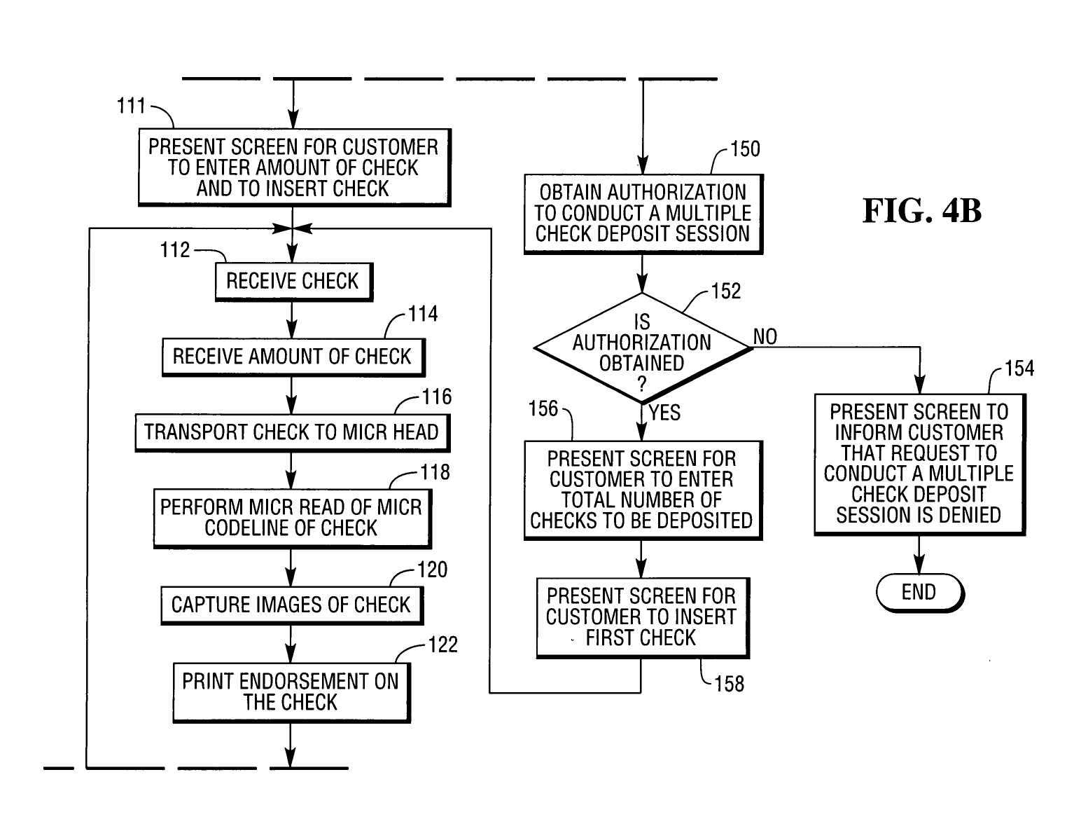

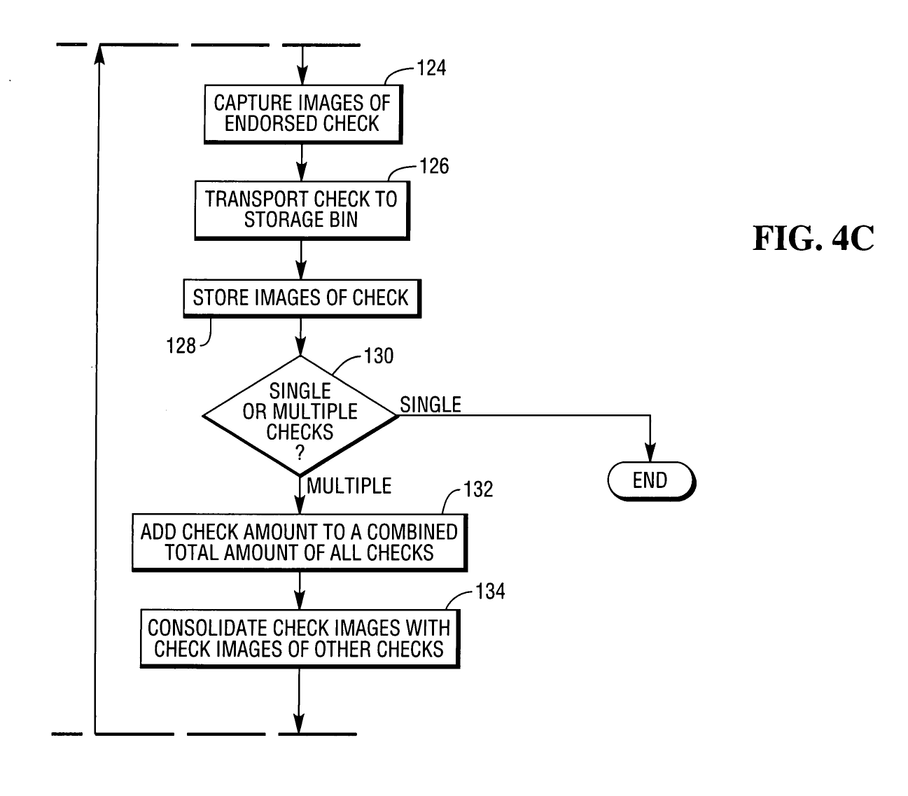

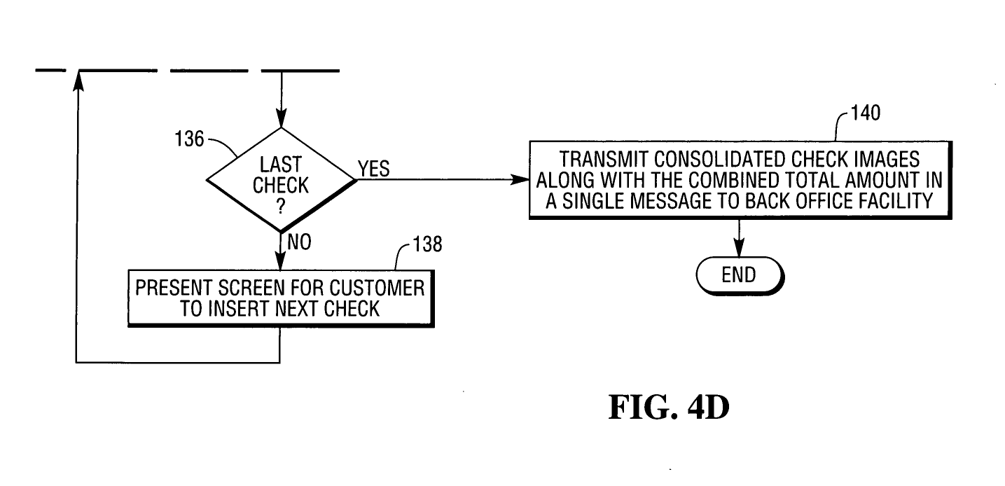

Referring to FIG. 4, a flowchart 100 illustrates steps involved in a check depositing transaction in accordance with one embodiment of the present invention. In the check depositing transaction, the ATM customer inserts a customer identification card into the card reader slot 46 and enters identifying data, like a personal identification number (PIN) to start the transaction (steps 102 and 104). The ATM customer is presented with a screen on the display 36 to select a transaction from a list of transaction options, and selects the “check depositing” option (step 106). The ATM customer also selects an account into which the deposit is to be made (step 108).

The ATM customer is then presented with a screen to select either a single check deposit transaction or a multiple check transaction (step 109). If a single check deposit transaction is selected (step 110), then the ATM customer is presented with a screen to enter the amount of the check via the keyboard 34, and to insert the check to be deposited through the check input/output slot 52 (step 111). The ATM customer inserts the check (step 112), and enters the amount of the check (step 114). The controller 76 receives the amount of the check. The infeed unit 62 receives the check and transports the check to the inlet 63 of the transport unit 64. The transport mechanism 70 of the transport unit 64 receives the check and transports the check (step 116) to the MICR head 72 where the MICR codeline on the check is read (step 118).

The transport mechanism 70 transports the check to the imager 74, where both sides of the check are imaged (step 120). The endorser printer 80 prints endorsement data onto the check (step 122). The endorsed check is then transported to the imager 74 to image the endorsed check (step 124) before it is transported through the outlet 67 to the storage bin 78 of the pocket unit 66 (step 126) for subsequent collection and further processing. Although the above describes both steps 120 and 124 being performed, it is conceivable that only one of these steps be performed. Preferably, step 120 is performed, and step 124 is optionally performed.

The captured check images are stored in the image data memory 75 (step 128). The captured check images may be grayscale images or binary images, for examples. The check images may be stored locally to the ATM 10. For example, the check images may be stored on an ATM hard drive located within the ATM 10 for a period of time determined by the financial institution. The process then proceeds to step 130.

If the ATM customer selected a single check deposit transaction back in step 110, then the process from step 130 will terminate. However, if the ATM customer selected a multiple check deposit check transaction back in step 110, then the process would have proceeded from step 110 to step 150. In step 150, the controller 76 sends a message to an ATM host processor (not shown) to request an authorization for the ATM customer to conduct a multiple check deposit session. Then in step 152, the ATM host processor makes a determination as to whether authorization should be granted based upon the customer identification card and identifying data received in steps 102 and 104 and the account information received back in step 108.

If authorization is denied, then the ATM customer is presented with a screen on the display 36 to inform the customer that the request to conduct a multiple check deposit session has been denied (step 154), and the process terminates. However, if authorization is granted, then the ATM customer is presented with a screen to enter the total number of checks to be deposited in the multiple check depositing session (step 156). After this number is entered, the ATM customer is presented with a screen to insert the first check for deposit (step 158). The process proceeds to step 112 and processes this first inserted check in the same manner from steps 112 to 128 as already described hereinabove.

When a determination is made in step 130 that a multiple check depositing session is in progress, the process proceeds to step 132. In step 132, the amount of the check currently being processed is added to a combined total of all checks being deposited for this multiple check depositing transaction. Check images which have been previously captured are consolidated with check images of all other checks being deposited for this multiple check depositing transaction (step 134).

A determination is then made in step 136 as to whether the check being currently processed is the last check to be processed for the multiple check depositing transaction. The controller 76 could make this determination based upon the number entered by the ATM customer back in step 156. If the determination in step 136 is negative, the process proceeds to step 138 in which a screen is presented for the ATM customer to insert the next check to be deposited for the multiple check depositing transaction. The process loops back to step 112 and processes the check in the same manner from steps 112 to 128 as already described hereinabove. Since this is a multiple check depositing transaction, steps 132 and 134 are also performed to update the combined total amount of all checks and to update the consolidated check images. When the last check of the multiple check depositing transaction is processed, as determined in step 130, the process proceeds to step 140. In step 140, the total amount of all checks from step 132 and the consolidated check images from step 134 are transmitted in a single message to a back office facility of a financial institution for further processing.

It should be apparent that a way is provided for check depositor to aggregate a plurality of checks to be deposited and perform a single deposit transaction for the aggregation. By enabling the check depositor to perform a single deposit transaction for a plurality of checks, the check depositor would incur one service fee for depositing the plurality of checks. Moreover, the owner of the ATM would incur one “click fee” for the check depositor having deposited the plurality of checks.

Also, it should be apparent that queues at the ATM should be reduced as a result of the check depositor being able to deposit the plurality of checks in a single check deposit transaction rather than in a multiple number of separate single check deposit transactions. The queues should reduced because the amount of time taken for the check depositor to conduct a single check deposit transaction to make the deposit of a plurality of checks should be less than the amount of time taken for the check depositor to conduct a multiple number of check deposit transactions to make the deposit of he plurality of checks.

Although the above description describes an ATM host processor as providing authorization for the ATM customer to perform a multiple check deposit session, it is conceivable authorization may be obtained in a different way. For example, authorization may be obtained through network authorization. In this case, a network such as an ATM network would be responsible for managing the multiple checks being deposited.

Further, although the above description describes the amount of each check being entered by the check depositor, it is conceivable that software which is capable of automatically reading the amount of each check be provided to accomplish this function.

Also, although the above-description describes the PERSONAS (trademark) 6676 NCR ATM embodying the present invention, it is conceivable that other models of ATMs, other types of ATMs, or other types of self-service check depositing terminals may embody the present invention. Self-service depositing terminals are generally public-access devices that are designed to allow a user to conduct a check deposit transaction in an unassisted manner and/or in an unattended environment. Self-service check depositing terminals typically include some form of tamper resistance so that they are inherently resilient.

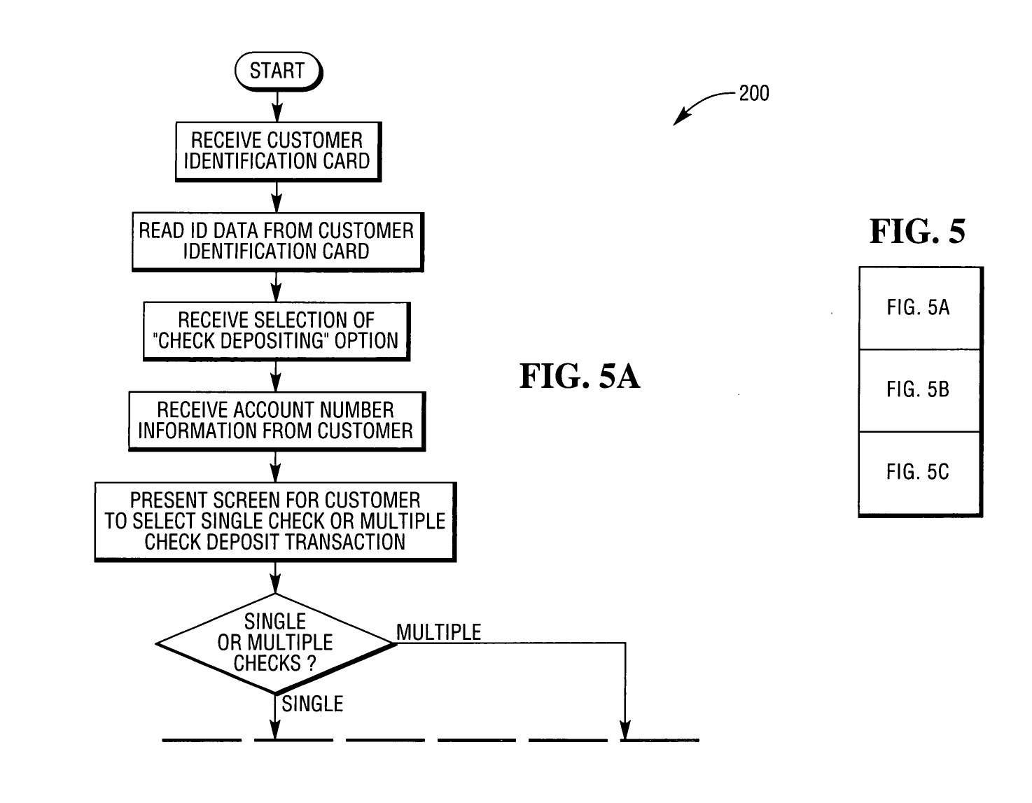

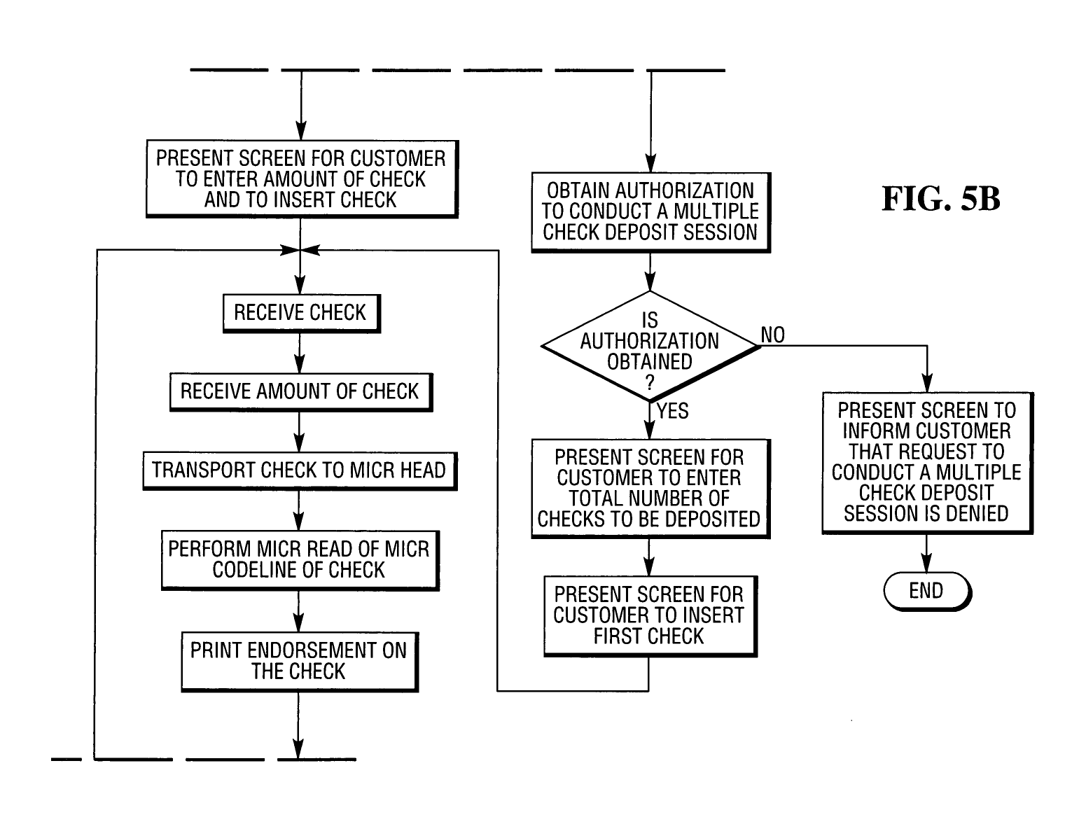

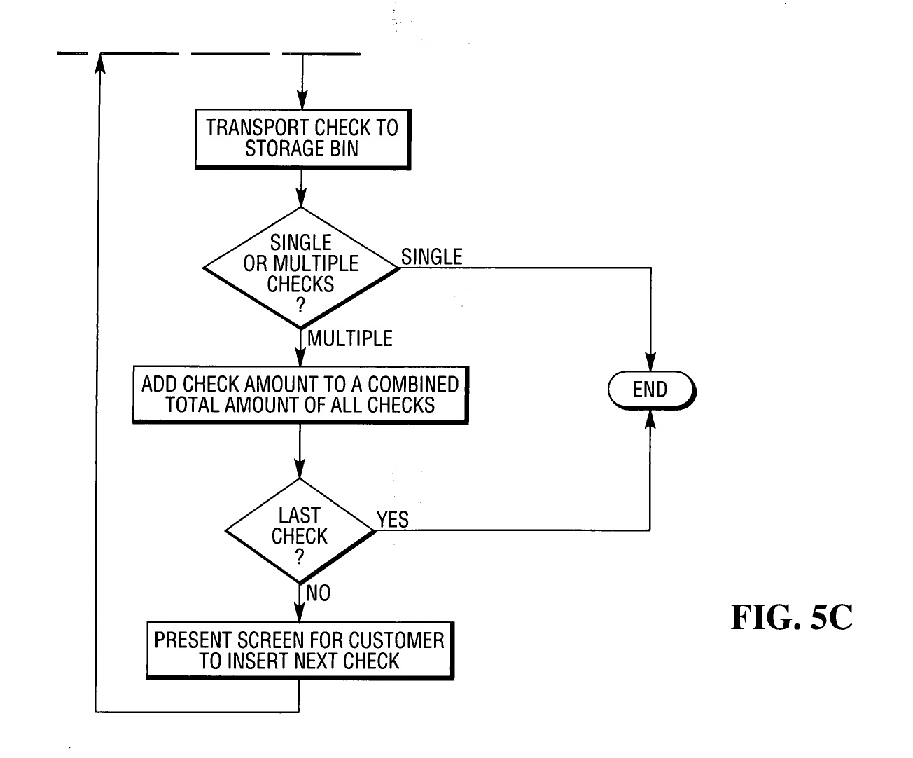

Although the above-description describes an aggregated single depositing transaction at an image-enabled ATM, it is conceivable that the transaction be conducted at a non-image-enabled ATM. For example, referring to FIG. 5, a flowchart 200 illustrates steps involved in a check depositing transaction in accordance with another embodiment of the present invention. The flowchart 200 of FIG. 5 is the same as the flowchart of FIG. 4, except that steps 120, 124, 128, 134, and 140 shown in FIG. 4 are omitted from FIG. 5 since the embodiment of FIG. 5 is a non-image-enabled terminal.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. A method of operating a self-service check depositing terminal having a single-check acceptor, the method comprising:
receiving a request from a depositor to conduct a check deposit transaction to deposit a plurality of checks;
after receiving the request, obtaining a single authorization to allow the depositor to conduct the check deposit transaction to deposit the plurality of checks;
after obtaining the single authorization, sequentially receiving the plurality of checks from the depositor; and
after receiving the plurality of checks, providing a single check deposit transaction message to allow the check deposit transaction to be completed.

2. A method according to claim 1, further comprising:
sequentially receiving the amount of each of the plurality of checks;
combining the amounts of the plurality of checks to provide a combined amount; and
providing the combined amount to allow the check deposit transaction to be completed.

3. A method of operating a self-service check depositing terminal, the method comprising:
receiving a request from a depositor to deposit a first check item and a second check item;
in response to receiving the request from the depositor to deposit the first and second check items, obtaining a single authorization to allow the depositor to deposit the first and second check items;
presenting a first display screen to allow the depositor to enter the amount of the first check item to be deposited;
receiving the amount of the first check item entered by the depositor;
after receiving the amount of the first check item, receiving the physical first check item from the depositor;
after receiving the physical first check item from the depositor, presenting a second display screen to allow the depositor to enter the amount of the second check item to be deposited;
receiving the amount of the second check item entered by the depositor;
after receiving the amount of the second check item, receiving the physical second check item from the depositor,
after receiving the physical second check item from the depositor, combining the amount of the first check item and the amount of the second check item to provide a total amount of the first and second check items; and
providing a transaction message along with the total amount of the first and second check items.

4. A method according to claim 3, further comprising:
transmitting the transaction message along with the total amount of the first and second check items to a financial institution.

5. A method of operating an automated teller machine (ATM) having a single-check acceptor, the method comprising:
receiving a request from an ATM customer to conduct a check deposit transaction to deposit a plurality of checks;
after receiving the request, obtaining from an ATM host processor single authorization to allow the ATM customer to conduct the check deposit transaction to deposit the plurality of checks;
after obtaining the single authorization, sequentially receiving the plurality of checks from the ATM customer via the single-check acceptor; and
after receiving the plurality of checks, sending to the ATM host processor a check deposit transaction message to allow the ATM host processor to complete the check deposit transaction.

6. A method according to claim 5, further comprising:
sequentially receiving the amount of each of the plurality of checks;
combining the amounts of the plurality of checks to provide a total amount of the plurality of checks; and
sending the total amount to the ATM host processor.

7. A method of operating an automated teller machine (ATM) having a single-check acceptor, the method comprising:
receiving a request from an ATM customer to conduct a check deposit transaction to deposit a plurality of checks;
after receiving the request, obtaining from an ATM network a single authorization to allow the ATM customer to conduct the check deposit transaction to deposit the plurality of checks;
after obtaining the single authorization, sequentially receiving the plurality of checks from the ATM customer via the single-check acceptor; and
after receiving the plurality of checks, sending to the ATM network a check deposit transaction message to allow the ATM network to complete the check deposit transaction.

8. A method according to claim 7, further comprising:
sequentially receiving the amount of each of the plurality of checks;
combining the amounts of the plurality of checks to provide a total amount of the plurality of checks; and
sending the total amount to the ATM network.
